(19) United States
(12) Patent Application Publication
(10) Pub. No.: US 2018/0326585 A1
(43) Pub. Date: Nov. 15, 2018

(54) Robot And Robot System

(71) Applicant: Seiko Epson Corporation, Tokyo (JP)

(72) Inventors: Hidekatsu MIYASAKA, Matsumoto (JP); Yuki KOBARI, Matsumoto (JP)

(21) Appl. No.: 15/971,029

(22) Filed: May 4, 2018

(30) Foreign Application Priority Data
May 11, 2017 (JP) 2017-094937

(51) Int. Cl. B25J 9/16; B25J 9/00

(52) U.S. Cl. CPC B25J 9/1664; B25J 9/0009; Y10S 901/29; Y10S 901/08; B25J 9/0084

(57) ABSTRACT

A robot includes an n-th (n is at least one integer that is equal to or greater than 1) arm that is rotatable around an n-th rotation axis; and a (n+1)-th arm that is provided on the n-th arm in a manner that is rotatable around an (n+1)-th rotation axis in an axis direction that is different from an axis direction of the n-th rotation axis, in which the n-th arm has an opening portion that includes the n-th rotation axis when viewed from the axis direction of the n-th rotation axis and has a guide that guides wiring in a direction that is different from a direction which is perpendicular to the n-th rotation axis.

### BACKGROUND

### 1. Technical Field

The present invention relates to a robot, and a robot system.

### 2. Related Art

A robot with a robot arm is known in the related art. The robot arm has a structure in which a plurality of arms are connected to each other through joint portions. That is, the robot arm, for example, includes a first arm, a second arm, a third arm, a fourth arm, a fifth arm, and a six arm in a direction from the base end side to the front end side, and for example, a hand is mounted, as an end effector, on the sixth arm that is farthest forward. Furthermore, when the robot operates, in order that a cable (wiring) which is connected to the hand is not an obstacle, a through-hole is provided in the fifth arm and the sixth arm and the cable is inserted into and passes through the through-hole. A joint portion is driven by a motor, and the arm rotates by drive of the joint portion. Then, the robot, for example, holds a target object with the hand, causes the target object to move to a prescribed place, and performs a prescribed job, such as assembling.

As the robot that is configured in this manner, a vertical articulated robot that includes the first arm, the second arm, the third arm, the fourth arm, the fifth arm, and the sixth arm is disclosed in JP-A-2015-160305.

In the robot that is illustrated in JP-A-2015-160305, a cable runs out of a base end portion of the fourth arm to the outside, runs from a front end portion back into the fourth arm, passes through the fifth arm and the sixth arm, and is connected to the end effector.

However, in the robot that is disclosed in JP-A-2015-160305, regulation of the cable within the robot arm is insufficient. For this reason, a difference in length of the cable, which is necessary in a case where the fifth arm is straightened and in a case where the fifth arm is curved, is increased and variation in the difference is increased. Therefore, there is a need to provide a comparatively long extra length on the cable such that the fifth arm can rotate smoothly, and there is variation in the extra length. Furthermore, there is a problem in that there is a need for comparatively more space in which the extra length of the cable freely moves within the robot arm and in that the robot arm is increased in size.

### SUMMARY

An advantage of some aspects of the invention is to solve at least a part of the problems described above, and the invention can be implemented as the following forms or application examples.

Ac robot according to an aspect of the invention includes: an n-th (n is at least one integer that is equal to or greater than 1) arm that is rotatable around an n-th rotation axis; and an (n+1)-th arm that is provided on the n-th arm in a manner that is rotatable around an (n+1)-th rotation axis in an axis direction that is different from an axis direction of the n-th rotation axis, in which the n-th arm has an opening portion that includes the n-th rotation axis when viewed from the axis direction of the n-th rotation axis and has a guidance unit that guides wiring in a direction that is different from a direction which is perpendicular to the n-th rotation axis.

With the robot that is configured in this manner, the wiring can be precisely regulated within the n-th arm, and thus the extra length of the wiring can be shortened, and variation in the extra length of the wiring can be decreased.

In the robot according to the aspect of the invention, it is preferable that the guidance unit guides the wiring along the n-th rotation axis.

With this configuration, the extra length of the wiring can be precisely shortened, and the variation in the extra length of the wiring can be decreased.

In the robot according to the aspect of the invention, it is preferable that the (n+1)-th arm has a through-hole and that the wiring passes through the through-hole.

With this configuration, the cable can be inserted into and pass through the through-hole, and the cable can be connected to an end effector.

In the robot according to the aspect of the invention, it is preferable that the guidance unit has a portion that causes a direction of guiding the wiring to be inclined with respect to the n-th rotation axis. Accordingly, the wiring can be precisely guided.

In the robot according to the aspect of the invention, it is preferable that the guidance unit has a portion that is detachably attached to at least the n-th arm.

Accordingly, the wiring can be easily provided within the n-th arm.

In the robot according to the aspect of the invention, it is preferable that an m-th (m is at least one integer that is equal to or greater than 1) arm that is rotatable around an m-th rotation axis and an (m+1)-th arm that is provided on the m-th arm in a manner that is rotatable around an (m+1)-th rotation axis in an axis direction that is different from an axis direction of the m-th rotation axis are further included, and that at least one of the m-th arm and the (m+1)-th arm includes a cover that has a position determination unit for performing alignment between the m-th arm and the (m+1)-th arm.

With this configuration, in a case where maintenance of the robot or the like is performed, the maintenance or the like can be easily performed by detaching the cover. Then, after the maintenance is ended, in a case where the cover is attached, the positioning of the (m+1)-th arm with respect to the m-th arm can be easily and quickly set to be suitable positioning (for example, basic positioning), using the position determination unit.

In the robot according to the aspect of the invention, it is preferable that an m-th (m is at least one integer that is equal to or greater than 1) arm that is rotatable around an m-th rotation axis and an (m+1)-th arm that is provided on the m-th arm in a manner that is rotatable around an (m+1)-th rotation axis in an axis direction that is different from an axis direction of the m-th rotation axis are provided, that at least one of the m-th arm and the (m+1)-th arm has an arm main-body unit and a cover, and that the cover includes a first position determination unit for performing alignment between the arm main-body unit and the cover, and a second position determination unit for performing alignment between the m-th arm and the (m+1)-th arm.

With this configuration, in the case where the maintenance of the robot or the like is performed, the maintenance or the like can be easily performed by detaching the cover. Then, after the maintenance is ended, in a case where the cover is attached, the positioning of the (m+1)-th arm with respect to the m-th arm can be easily and quickly set, by the first position determination unit and the second position determination unit, to be the suitable positioning (for example, the basic positioning).

A robot control apparatus according to another aspect of the invention controls drive of the robot according to the aspect of the invention.

With the robot control apparatus according to the aspect of the invention that is configured in this manner, when it comes to the robot that is controlled, the wiring can be precisely regulated within the n-th arm. Thus, the extra length of the wiring can be shortened, and variation in the extra length of the wiring can be decreased.

A robot system according to another aspect of the invention includes the robot according to the aspect of the invention and a robot control apparatus that controls the drive of the robot.

With the robot system according to the aspect of the invention that is configured in this manner, the wiring can be precisely regulated within the n-th arm, and thus the extra length of the wiring can be shortened, and variation in the extra length of the wiring can be decreased.

### BRIEF DESCRIPTION OF THE DRAWINGS

The invention will be described with reference to the accompanying drawings, wherein like numbers reference like elements.

FIG. 1 is a perspective diagram illustrating a robot (a robot system) according to a first embodiment of the invention.

FIG. 2 is a schematic diagram of a robot that is illustrated in FIG. 1.

FIG. 3 is a front-view diagram of the robot that is illustrated in FIG. 1.

FIG. 4 is a front-view diagram of the robot that is illustrated in FIG. 1.

FIG. 5 is a front-view diagram of the robot that is illustrated in FIG. 1.

FIG. 6 is a block diagram of the robot (the robot system) that is illustrated in FIG. 1.

FIG. 7 is a perspective diagram of a fourth arm of the robot that is illustrated in FIG. 1.

FIG. 8 is a perspective diagram of a partial cross-section of the fourth arm of the robot that is illustrated in FIG. 1.

FIG. 9 is a perspective diagram illustrating a state where a lid of a guidance unit of the fourth arm of the robot that is illustrated in FIG. 1 is removed.

FIG. 10 is a perspective diagram illustrating the lid that constitutes the guidance unit of the robot that is illustrated in FIG. 1.

FIG. 11 is a cross-sectional diagram of the fourth arm, a fifth arm and a sixth arm of the robot that are illustrated in FIG. 1.

FIG. 12 is a cross-sectional diagram of the fourth arm, the fifth arm and the sixth arm of the robot that are illustrated in FIG. 1.

FIG. 13 is a cross-sectional diagram of the fourth arm, the fifth arm and the sixth arm that are illustrated in FIG. 1.

FIG. 14 is a cross-sectional diagram of a fourth arm, a fifth arm, and a sixth arm in a robot (a robot system) according to a second embodiment of the invention.

FIG. 15 is a cross-sectional diagram of a fourth arm, a fifth arm, and a sixth arm in a robot (a robot system) according to a third embodiment of the invention.

FIG. 16 is a perspective diagram illustrating a robot (a robot system) according to a fourth embodiment of the invention.

FIG. 17 is a perspective diagram illustrating a state where a cover is removed in the robot that is illustrated in FIG. 16.

FIG. 18 is a front-view diagram illustrating a component of a robot arm of the robot that is illustrated in FIG. 16.

FIG. 19 is a perspective diagram illustrating a cover of the robot arm of the robot that is illustrated in FIG. 16.

FIG. 20 is a perspective diagram illustrating the cover of the robot arm of the robot that is illustrated in FIG. 16.

### DESCRIPTION OF EXEMPLARY EMBODIMENTS

A robot, a robot control apparatus, and a robot system according to aspects of the invention will be described in detail below based on embodiments that are illustrated in the accompanying drawings.

Furthermore, in the following embodiments, a case where n and m that are recited in the appended Claims are 4 and 3, respectively, is given as an example for description, and n may be at least one integer that is equal to or greater than 1 and m may be at least one integer that is equal to or greater than 1. Furthermore, n and m may be the same and may be different from each other.

### First Embodiment

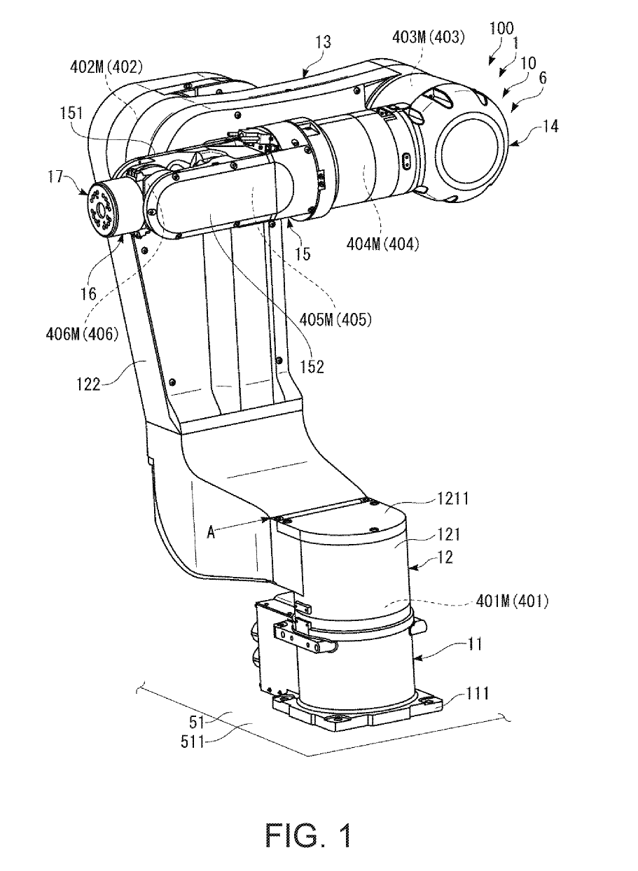

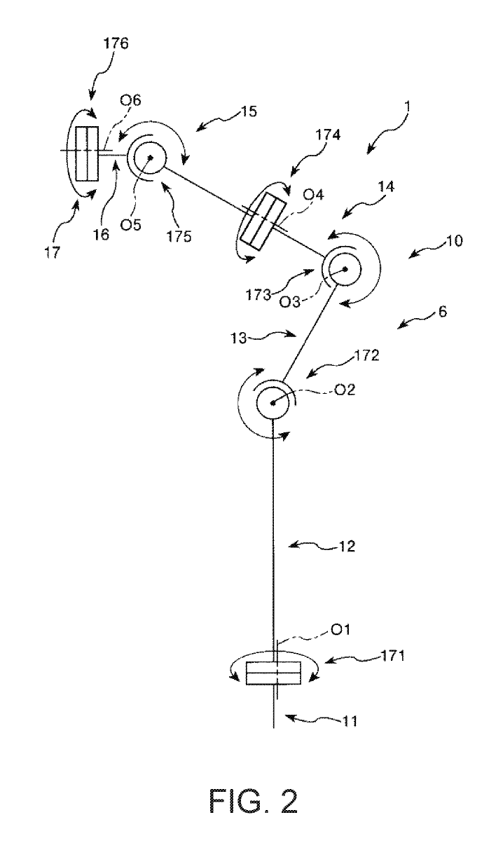

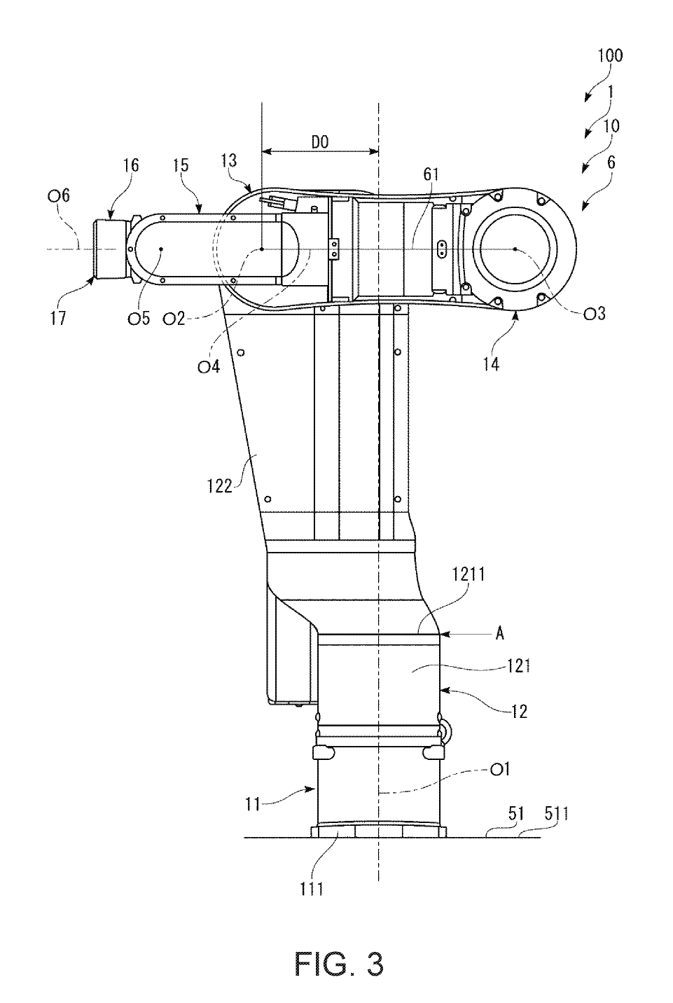

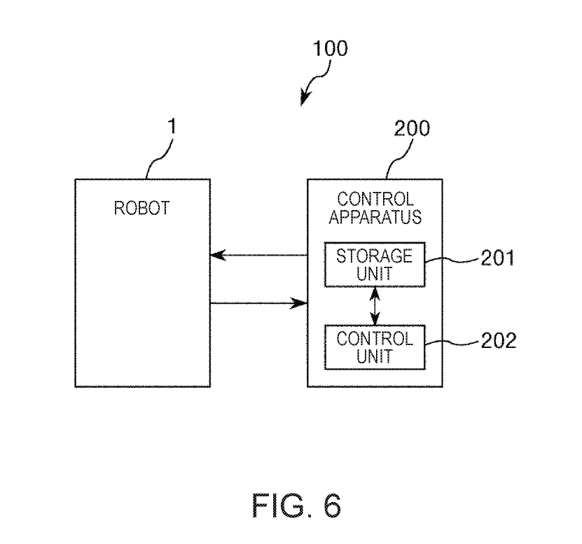

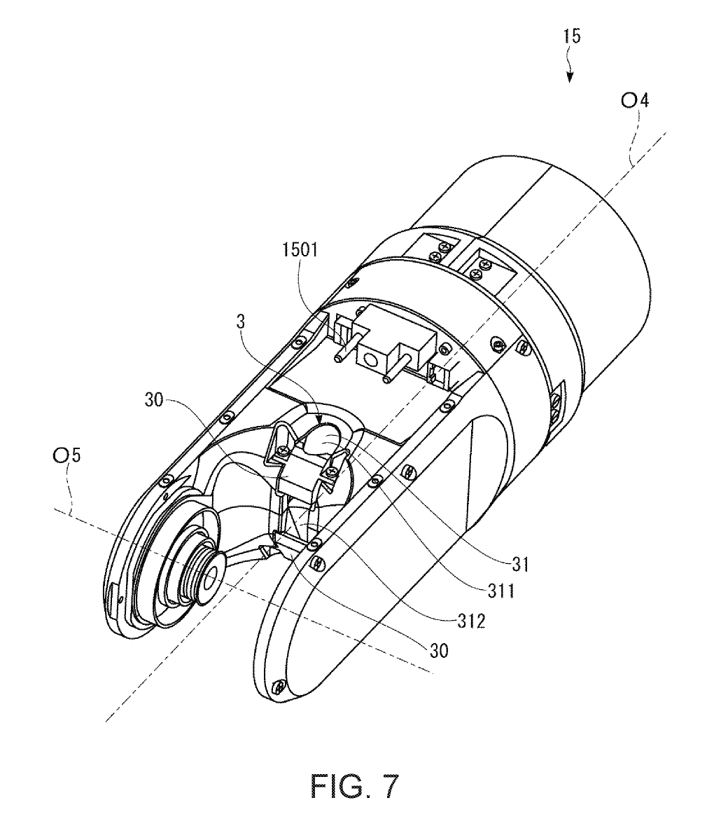

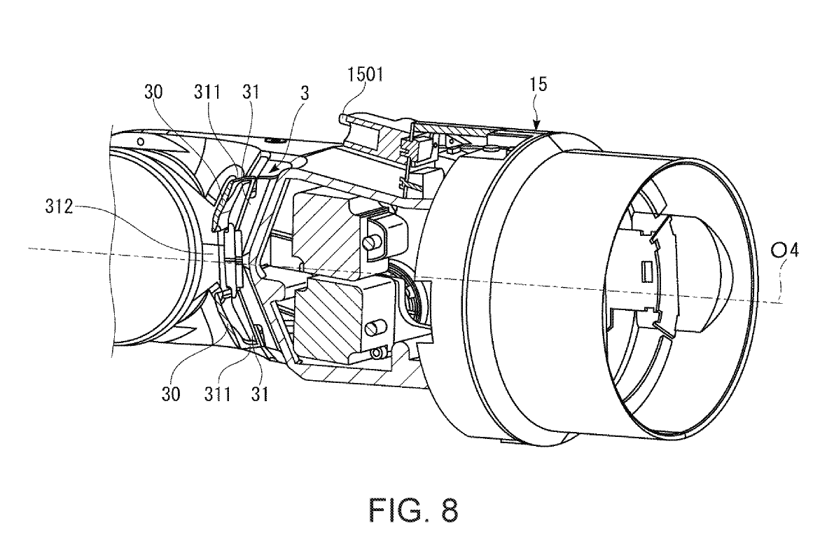

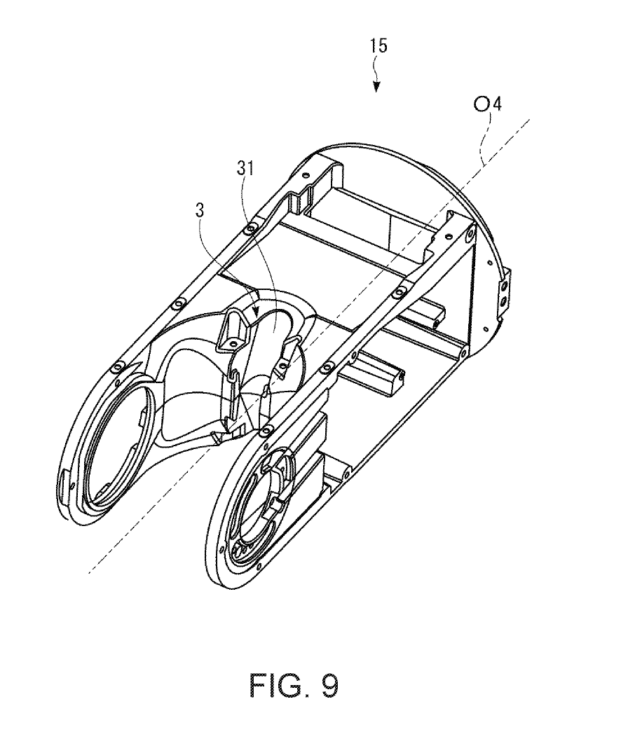

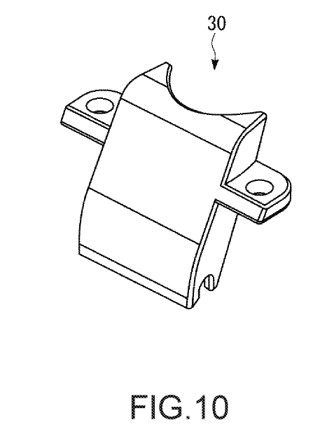

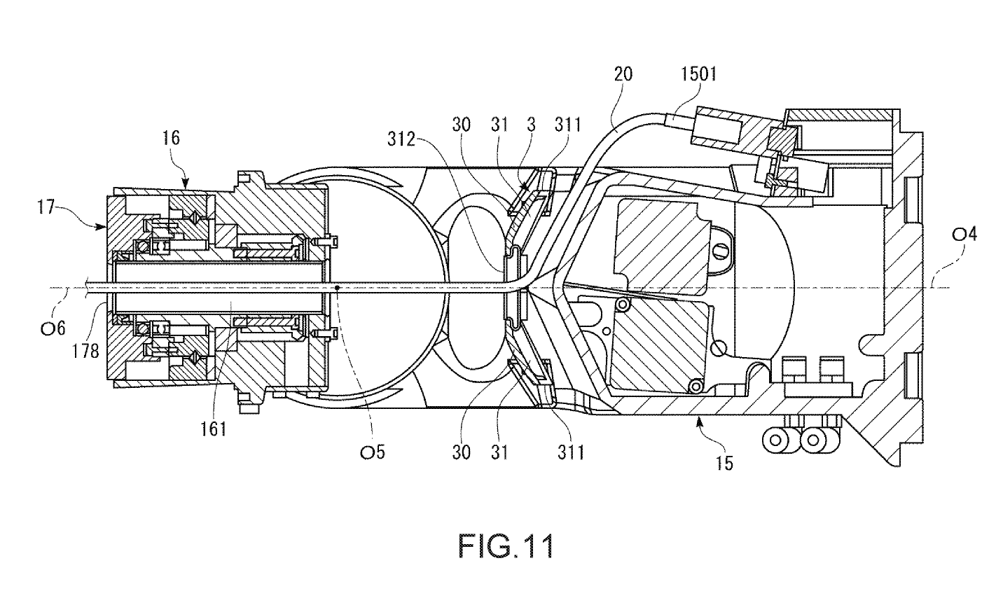

FIG. 1 is a perspective diagram illustrating a robot (a robot system) according to a first embodiment of the invention. FIG. 2 is a schematic diagram illustrating the robot in FIG. 1. FIGS. 3 to 5 are front-view diagrams, each of which illustrates the robot that is illustrated in FIG. 1. FIG. 6 is a block diagram of the robot (robot system) that is illustrated in FIG. 1. FIG. 7 is a perspective diagram of a fourth arm of the robot that is illustrated in FIG. 1. FIG. 8 is a perspective diagram of a partial cross-section of the fourth arm of the robot that is illustrated in FIG. 1. FIG. 9 is a perspective diagram illustrating a state where a lid of a guidance unit (guide) of the fourth arm of the robot that is illustrated in FIG. 1 is removed. FIG. 10 is a perspective diagram illustrating the lid that constitutes the guidance unit of the robot that is illustrated in FIG. 1. FIGS. 11 to 13 are cross-sectional diagrams of the fourth arm, a fifth arm and a sixth arm of the robot that are illustrated in FIG. 1. Furthermore, in FIGS. 1, and 3 to 5, an illustration of a cable is omitted.

It is noted that, for convenience of description, the upper side of each of FIGS. 1 to 5 is referred to as “upward ” or an “upward direction” and the lower side is referred to as “downward” or a “downward direction.”Furthermore, the base side of each FIGS. 1 to 5 is referred to as a “base end” or “upstream,” and the opposite side is referred to as a “front end” or “downstream.” Furthermore, the upward-downward direction and the leftward-rightward direction in FIGS. 1 to 5 are defined as a “vertical direction” and a “horizontal direction,” respectively. Furthermore, in the present specification, the term “horizontal” means not only being completely horizontal, but also being inclined at an angle of ±5° with respect to the horizontal direction. In the same manner, in the present specification, the term “vertical” means not only being completely vertical, but also being inclined at an angle of ±5° with respect to the vertical direction. Furthermore, in the present specification, the term “parallel” means not only that two lines (including axes) or surfaces are completely parallel to each other, but also that an angle that one makes with respect to the other is in a range of ±5°. Furthermore, in the present specification, the term “perpendicular” means not only that two lines (including axes) or surfaces are completely perpendicular to each other, but also that an angle that one makes with respect to the other is in a range of ±5°. It is noted that this is true for figures of the other embodiments.

As illustrated in FIGS. 1 to 6, a robot system 100 (an industrial robot system) includes a robot 1 (an industrial robot) and a control apparatus 200 (a robot control apparatus) that controls drive of the robot 1. The robot system 100, for example, can be used in a manufacturing process or the like in which a precision device such as a wrist watch is manufactured. Furthermore, the robot system 100, for example, can perform jobs such as supplying, removing, transporting, and assembling of the precision device and a component that constitutes the precision device. It is noted that according to the invention, the robot 1 may have the control apparatus 200.

The control apparatus 200 includes a control unit 202 that performs each control, a storage unit 201 in which each information is stored, and the like. The control apparatus 200, for example, can be configured with a personal computer (PC) or the like into which a Central Processing Unit (CPU) (not illustrated) or the like is built, and controls a first motor 401M, a second motor 402M, a third motor 403M, a fourth motor 404M, a fifth motor 405M, a sixth motor 406M, an end effector, and the like of the robot 1 that will be described below. Furthermore, a program that controls the robot 1 is stored in advance in the storage unit 201.

One or several portions, or all portions of the control apparatus 200 may be built into the robot 1 (a robot main-body 10), and the control apparatus 200 may be an apparatus separate from the robot 1. It is noted that, in a case where a configuration is employed in which the robot 1 and the control apparatus 200 are apparatuses separate from each other, the robot 1 and the control apparatus 200, for example, may perform communication in a wired manner, in state of being electrically connected to each other with a cable (not illustrated), and may perform communication in a wireless manner with the cable being omitted.

The robot 1 includes a robot main-body 10, a first drive source 401, a second drive source 402, a third drive source 403, a fourth drive source 404, a fifth drive source 405, and a sixth drive source 406. The robot main-body 10 includes a base (a support unit) 11 and a robot arm 6.

The robot arm 6 has a first arm 12 that is provided on the base 11 in a manner that is rotatable around a first rotation axis O1, a second arm 13 that is provided on the first arm 12 in a manner that is rotatable around a second rotation axis O2 in an axis direction that is different from (that, in the present embodiment, orthogonally intersects) an axis direction of the first rotation axis O1, a third arm 14 that is provided on the second arm 13 in a manner that is rotatable around a third rotation axis O3, a fourth arm 15 that is provided on the third arm 14 in a manner that is rotatable around a fourth rotation axis O4, a fifth arm 16 that is provided on the fourth arm 15 in a manner that is rotatable around a fifth rotation axis O5, and a sixth arm 17 that is provided on the fifth arm 16 in a manner that is rotatable around a sixth rotation axis O6. It is noted that a wrist is configured with the fifth arm 16 and the sixth arm 17 and that for example, the end effector such as a hand can be detachably attached to a front end of the sixth arm 17 (a front end of the robot arm 6). The robot 1 will be described in detail.

A type of robot 1 is not particularly limited, but in the present embodiment, the robot 1 is a vertical articulated (six axes) robot in which the base 11, the first arm 12, the second arm 13, the third arm 14, the fourth arm 15, the fifth arm 16, and the sixth arm 17 in this order are connected to each other in a direction from the base end side to the front end side. The “vertical articulated robot” refers to a robot in which the number of rotation axes (the number of arms) is equal to or greater than 2 and in which among rotation axes, two rotation axes intersect (orthogonally intersect) each other. It is noted that each of the first arm 12, the second arm 13, the third arm 14, the fourth arm 15, the fifth arm 16, and the sixth arm 17 is hereinafter referred to as the “arm.” Furthermore, each of the first drive source 401, the second drive source 402, the third drive source 403, the fourth drive source 404, the fifth drive source 405, and the sixth drive source 406 is also referred to as the “drive source.”

As illustrated in FIG. 3, the base 11 is a portion (a member that is attached) that is fixed (supported on) to a prescribed portion in an installation space. This fixing method is not particularly limited, and for example, a method of performing fixation using a plurality of bolts can be employed.

In the present embodiment, the base 11 is fixed to a floor surface 511 of a floor 51 (a floor portion) in the installation space. The floor surface 511 is a plane in parallel to a horizontal plane. It is noted that a plate-shaped flange 111 that is provided on a base end portion of the base 11 is attached to the floor surface 511, but a place for attaching the base 11 to the floor surface 511 is not limited to this.

It is noted that a joint 171, which will be described below, may be included in the base 11 and may not be included in the base 11 (refer to FIG. 2).

Furthermore, each of the first arm 12, the second arm 13, the third arm 14, the fourth arm 15, the fifth arm 16, and the sixth arm 17 is supported in such a manner that displacement is possible independently of the base 11.

As illustrated in FIGS. 1 and 3, the first arm 12 takes a bent shape. That is, with reference to states in FIGS. 1 and 3, the first arm 12 is described as being connected (provided on) to the base 11, and as having a first portion 121 that extends toward the upper side in FIG. in the axis direction (the vertical direction) of the first rotation axis O1, which will be described below, away from the base 11, and a second portion 122 that extends to the left side in FIG. 1 in the axis direction (the horizontal direction) of the second rotation axis O2 away from a flank portion in FIG. 1, of the first portion 121, curves by 90° on the way, and extends toward the upper side in FIG. 1 in the axis direction (the vertical direction) of the first rotation axis O1. In the present embodiment, a portion of the second portion 122, which extends toward the left side in FIG. 1 from the flank portion in FIG. 1, of the first portion 121, is somewhat inclined toward the upper side in FIG. 1 rather than being in the complete horizontal direction. Furthermore, the first portion 121 has a flat plane portion 1211 on the upper side in FIG. 1. The first portion 121 and the second portion 122 are formed into one piece. A border A between the first portion 121 and the second portion 122 is as illustrated. It is noted that the shape of the first arm 12 is one example, and no limitation to the shape is imposed.

The second arm 13 takes a longitudinal shape, and is connected to (provided on) a front end portion of the first arm 12, that is, a front end portion of the second portion 122.

The third arm 14 takes a longitudinal shape, and is connected to (provided on) a front end portion of the second arm 13.

The fourth arm 15 is connected to (provided on) a front end portion of the third arm 14. The fourth arm 15 has a pair of support units, the support units 151 and 152 that face each other. The support units 151 and 152 are used for connection of the fourth arm 15 to the fifth arm 16.

The fifth arm 16 is positioned between the support units 151 and 152 and is connected to the support units 151 and 152, and thus is connected to the fourth arm 15 (provided on the fourth arm 15). It is noted that the fourth arm 15 is not limited to this structure, and for example, one support unit (a cantilever) may present.

The sixth arm 17 is connected to (provided on) a front end portion of the fifth arm 16. Furthermore, a hand that holds, for example, the precision device, such as the wrist watch, and the component is mounted as the end effector in an attachable and detachable manner in a front end portion (an end portion that is opposite in direction to the fifth arm 16) of the sixth arm 17. Drive of the hand is controlled by the control apparatus 200. It is noted that the hand is not particularly limited and that, for example, a hand which is configured to have a plurality of fingers is given. Then, by controlling operation of each of the arms 12 to 17 and the like while holding the precision device and the component using the hand, the robot 1 can perform jobs such as transporting the precision device and the component.

As illustrated in FIGS. 1 to 3, the first arm 12 is provided on the base 11. Accordingly, in a case where the robot 1 is installed, by installing the base 11, a job of the installation can be performed.

Specifically, the base 11 and the first arm 12 are connected with each other through the joint 171. The joint 171 has a mechanism that supports the first arm 12 in a manner that is rotatable with respect to the base 11. Accordingly, the first arm 12 is rotatable about the first rotation axis O1 (around the first rotation axis O1) that extends in (runs along) the vertical direction, with respect to the base 11. Furthermore, the first rotation axis O1 is consistent with a line normal to the floor surface 511 of the floor 51 to which the base 11 is attached. Furthermore, the first rotation axis O1 is a rotation axis that is present on the most upstream side of the robot 1. The rotation around the first rotation axis O1 is made by drive of the first drive source 401 that is a first drive unit (a drive unit) which has the first motor 401M and a speed reduction gear (not illustrated).

Furthermore, an angle at which the first arm 12 is rotatable is not particularly limited, but is preferably set to 90° or less. Accordingly, even in a case where an obstacle is present around the robot 1, the robot 1 can operate while avoiding the obstacle, and a tact time can be shortened.

It is noted that in the following, each of the first motor 401M and the second motor 402M, the third motor 403M, the fourth motor 404M, the fifth motor 405M and the sixth motor 406M which will be described below is also referred to as the “motor.”

Furthermore, the first arm 12 and the second arm 13 are connected to each other through a joint 172. The joint 172 has a mechanism that supports one of the first arm 12 and the second arm 13 in a manner that is rotatable with respect to the other. Accordingly, the second arm 13 is rotatable about the second rotation axis O2 (around the second rotation axis O2) that extends in (runs along) the horizontal direction, with respect to the first arm 12. Furthermore, the second rotation axis O2 and the first rotation axis O1 are present at a position for torsion, and the second rotation axis O2 is in parallel to an axis that orthogonally intersects (intersects) the first rotation axis O1. That is, as illustrated in FIG. 3, the second rotation axis O2 is positioned with only a distance D0 away from the first rotation axis O1 when viewed from the axis direction of the second rotation axis O2. The rotation around the second rotation axis O2 is made by drive of the second drive source 402 that is a second drive unit (a drive unit) which has the second motor 402M and a speed reduction gear (not illustrated).

Furthermore, the second arm 13 and the third arm 14 are connected to each other through a joint 173. The joint 173 has a mechanism that supports one of the second arm 13 and the third arm 14 in a manner that is rotatable with respect to the other. Accordingly, the third arm 14 is rotatable about the third rotation axis O3 (around the third rotation axis O3) that extends in (runs along) the horizontal direction, with respect to the second arm 13. Furthermore, the third rotation axis O3 is in parallel to the second rotation axis O2. The rotation around the third rotation axis O3 is made by drive of the third drive source 403 that is a third drive unit (a drive unit) which has the third motor 403M and a speed reduction gear (not illustrated).

Furthermore, the third arm 14 and the fourth arm 15 are connected to each other through a joint 174. The joint 174 has a mechanism that supports one of the third arm 14 and the fourth arm 15 in a manner that is rotatable with respect to the other. Accordingly, the fourth arm 15 is rotatable about the fourth rotation axis O4 (around the fourth rotation axis O4) with respect to the third arm 14 (the base 11). Furthermore, the fourth rotation axis O4 orthogonally intersects (intersects) the third rotation axis O3. The rotation around the fourth rotation axis O4 is made by drive of the fourth drive source 404 that is a fourth drive unit (a drive unit) which has the fourth motor 404M and a speed reduction gear (not illustrated).

It is noted that the fourth rotation axis O4 may be in parallel to an axis that orthogonally intersects (intersects) the third rotation axis O3. That is, the fourth rotation axis O4 and the third rotation axis O3 may be different in the axis direction from each other.

Furthermore, the fourth arm 15 and the fifth arm 16 are connected to each other through a joint 175. The joint 175 has a mechanism that supports one of the fourth arm 15 and the fifth arm 16 in a manner that is rotatable with respect to the other. Accordingly, the fifth arm 16 is rotatable about the fifth rotation axis O5 (around the fifth rotation axis O5) with respect to the fourth arm 15. Furthermore, the fifth rotation axis O5 orthogonally intersects (intersects) the fourth rotation axis O4. The rotation around the fifth rotation axis O5 is made by drive of the fifth drive source 405 that is a fifth drive unit (a drive unit). The fifth drive source 405 has the fifth motor 405M, the speed reduction gear (not illustrated), a first pulley (not illustrated) that is connected to an axis portion of the fifth motor 405M, a second pulley (not illustrated) that is positioned with a distance away from the first pulley and is connected to an axis portion of the speed reduction gear, and a belt (not illustrated) that is stretched over the first pulley and the second pulley.

It is noted that the fifth rotation axis O5 may be in parallel to an axis that orthogonally intersects (intersects) the fourth rotation axis O4. That is, the fifth rotation axis O5 and the fourth rotation axis O4 may be different in the axis direction from each other.

Furthermore, the fifth arm 16 and the sixth arm 17 are connected to each other through a joint 176. The joint 176 has a mechanism that supports one of the fifth arm 16 and the sixth arm 17 in a manner that is rotatable with respect to the other. Accordingly, the sixth arm 17 is rotatable about the sixth rotation axis O6 (around the sixth rotation axis O6) with respect to the fifth arm 16. Furthermore, the sixth rotation axis O6 orthogonally intersects (intersects) the fifth rotation axis O5. The rotation around the sixth rotation axis O6 is made by drive of the sixth drive source 406 that is a sixth drive unit (a drive unit) which has the sixth motor 406M and a speed reduction gear (not illustrated).

It is noted that the sixth rotation axis O6 may be in parallel to an axis that orthogonally intersects (intersects) the fifth rotation axis O5. That is, the sixth rotation axis O6 and the fifth rotation axis O5 may be different in the axis direction from each other.

It is noted that in each of the drive sources 401 to 406, the speed reduction gear may be omitted. Furthermore, brakes (braking systems) that control the arms 12 to 17, respectively, may be provided on the arms 12 to 17, respectively, and may be omitted.

The motors 401M to 406M are not particularly limited, and for example, servomotor, such as AC servomotors or DC servo motors, and the like, are given.

Furthermore, each of the brakes is not particularly limited, and for example, an electromagnetic brake or the like is given.

Furthermore, in the motors 401M to 406M of the drive sources 401 to 406 or in the speed reduction gears, a first encoder as a first position detection unit that detects a position of the first arm 12, a second encoder as a second position detection unit that detects a position of the second arm 13, a third encoder as a third position detection unit that detects a position of the third arm 14, a fourth encoder as a fourth position detection unit that detects a position of the fourth arm 15, a fifth encoder as a fifth position detection unit that detects a position of the fifth arm 16, and a sixth encoder as a sixth position detection unit that detects a position of the sixth arm 17, are respectively provided (none of the encoders is illustrated). With each encoder, a rotation angle of a rotation axis of each of the motors 401M to 406M of the drive sources 401 to 406 or each of the speed reduction gears is detected.

The configuration of the robot 1 is simply described above.

Next, relationships among the first arm 12 to the sixth arm 17 will be described and will be described in other expressions from various points of view. Furthermore, it is assumed that the third arm 14 to the sixth arm 17 are considered in a state where the third arm 14 to the sixth arm 17 are straight stretched, that is, in a state where the third arm 14 to the sixth arm 17 have their respective longest lengths, in other words, in a state where the fourth rotation axis O4 and the sixth rotation axis O6 are consistent with each other or are in parallel to each other.

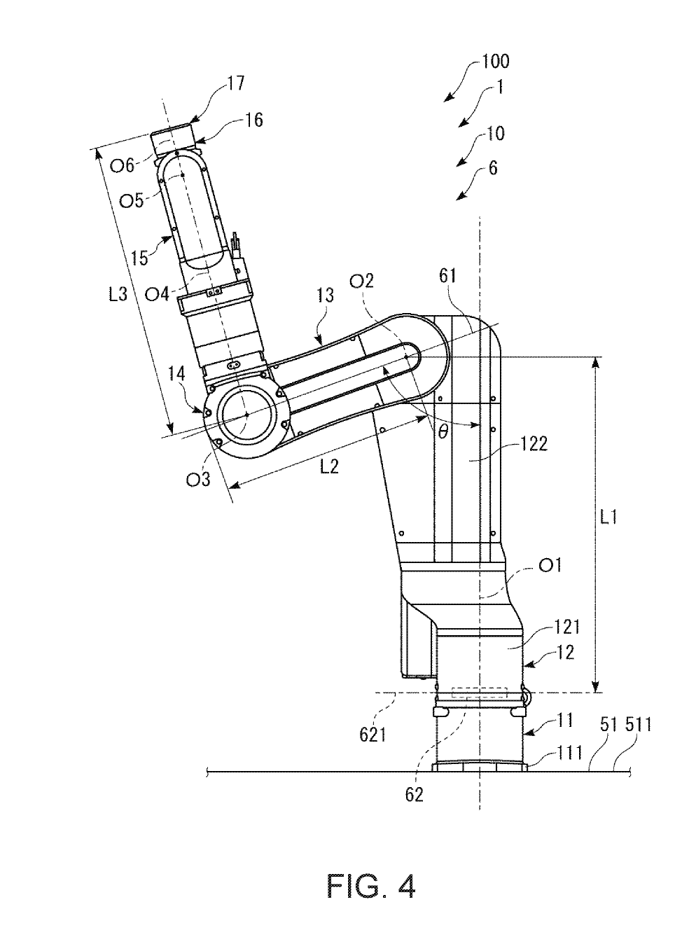

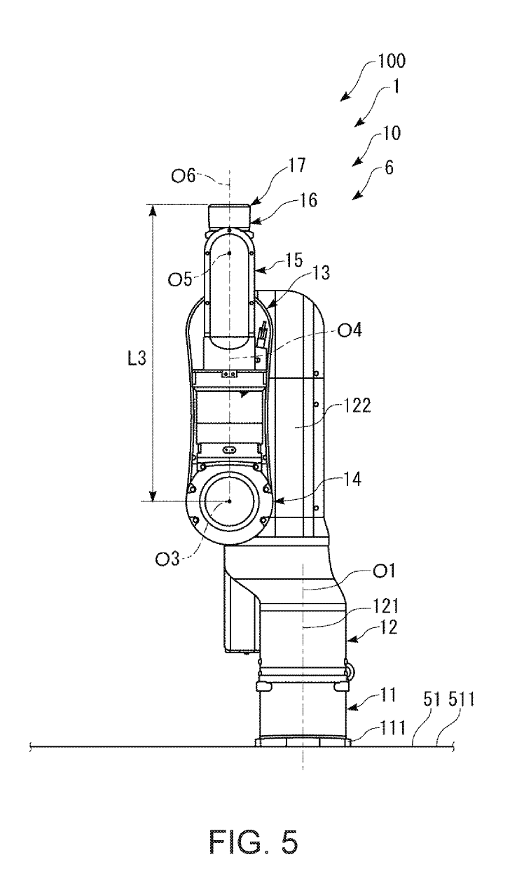

First, as illustrated in FIG. 4, a length L1 (an arm length) of the first arm 12 is longer than a length L2 of the second arm 13. Accordingly, as illustrated in FIG. 5, the first arm 12 and the second arm 13 can easily overlap each other when viewed from the axis direction of the second rotation axis O2 (refer to FIG. 4).

At this point, the length L1 of the first arm 12 is a distance between the second rotation axis O2 and a center line 621 that extends in the leftward-rightward direction in FIG. 4, of a bearing portion 62 which rotatably supports the first arm 12, when viewed from the axis direction of the second rotation axis O2.

Furthermore, as described above, the length L2 of the second arm 13 is a distance between the second rotation axis O2 and the front end of the second arm 13, when viewed from the axis direction of the second rotation axis O2.

Furthermore, as illustrated in FIG. 5, a configuration is employed in which an angle θ (refer to FIG. 4) that the first arm 12 (the first rotation axis O1) and the second arm 13 make with respect to each other is possibly set to 0°, when viewed from the axis direction of the second rotation axis O2 (refer to FIG. 4). In other words, a configuration is employed in which, when viewed from the axis direction of the second rotation axis O2, the first arm 12 and the second arm 13 possibly overlap each other, that is, a state where the first arm 12 and the second arm 13 overlap each other is possibly attained. Accordingly, in a case where the front end of the robot arm 6 is caused to move to a position that results from a 180° turn around the first rotation axis O1, a space that is necessary in order for the robot 1 not to cause interference can be reduced.

Furthermore, a configuration is employed in which, in a case where an angle θ is 0°, that is, in a case where the first arm 12 and the second arm 13 overlaps each other when viewed from the axis direction of the second rotation axis O2, the second arm 13 does not interfere with the first portion 121 of the first arm 12.

At this point, an angle θ that the first arm 12 and the second arm 13 make with respect to each other is an angle that a straight line 61 (a center axis of the second arm 13 when viewed from the axis direction of the second rotation axis O2) that passes through the second rotation axis O2 and the third rotation axis O3, and the first rotation axis O1 make with respect to each other when viewed from the axis direction of the second rotation axis O2.

Furthermore, by causing the second arm 13 to rotate without causing the first arm 12 to rotate, it is possible that the front end of the second arm 13 (the front end of the robot arm 6 (the front end of the sixth arm 17)) is caused to experience a state (a state where the first arm 12 and the second arm 13 overlap each other) where the angle θ is 0° when viewed from the axis direction of the second rotation axis O2 and then to move to the position that results from the 180° turning around the first rotation axis O1. It is noted that each of the third arm 14 to the sixth arm 17 is caused to rotate whenever necessary.

Furthermore, when the front end of the second arm 13 is caused to move to the position that results from the 180° turning around the first rotation axis O1 (when the front end of the robot arm 6 is caused to move to the position that results from the 180° turning around the first rotation axis O1), the front end of the second arm 13 and the front end of the robot arm 6 move in a straight line when viewed from the axis direction of the first rotation axis O1.

Furthermore, a length L3 (a maximum length) that is a sum of lengths of the third arm 14 to the sixth arm 17 is set to be longer than the length L2 of the second arm 13.

Accordingly, when the second arm 13 and the third arm 14 overlap each other when viewed from the axis direction of the second rotation axis O2, the front end of the sixth arm 17 can protrude from the second arm 13. Accordingly, the hand can be prevented from interfering with the first arm 12 and the second arm 13.

At this point, the length L3 (the maximum length) that is the sum of the lengths of the third arm 14 to the sixth arm 17 is a distance between the third rotation axis O3 and the front end of the sixth arm 17 when viewed from the axis direction of the second rotation axis O2 (refer to FIG. 4). In this case, the third arm 14 to the sixth arm 17, as illustrated in FIG. 4, are in a state where the fourth rotation axis O4 and the sixth rotation axis O6 are consistent with each other or are parallel to each other.

Furthermore, as illustrated in FIG. 5, a configuration is employed in which the second arm 13 and the third arm 14 possibly overlap each other when viewed from the axis direction of the second rotation axis O2.

That is, a configuration is employed in which the first arm 12, the second arm 13, and the third arm 14 overlap each other at the same time when viewed from the axis direction of the second rotation axis O2.

In the robot 1, by satisfying the relationship described above, the second arm 13 and the third arm 14 are caused to rotate without causing the first arm 12 to rotate. Thus, the front end of the sixth arm 17 (the hand) can be caused to experience a state (the state where the first arm 12 and the second arm 13 overlap each other) where the angle θ° that the first arm 12 and the second arm 13 make with respect to each other is 0° when viewed from the axis direction of the second rotation axis O2 and then to move to the position that results from the 180° turning around the first rotation axis O1. Then, by performing this operation, the robot 1 can be efficiently driven, the space that is necessary in order for the robot 1 not to cause interference can be decreased, and various advantages as described lastly are provided.

Furthermore, as described in FIGS. 1 and 3, the robot 1 can be positioned so that (can be in a state where), when viewed from the axis direction of the second rotation axis O2, the second arm 13 and the third arm 14 overlap each other, and the straight line 61 which passes through the second rotation axis O2 and the third rotation axis O3 orthogonally intersects (intersects) the first rotation axis O1. The positioning of the robot 1 that is illustrated in FIG. 3 is basic positioning of the robot 1.

The basic positioning of the robot 1 (the robot arm 6) refers to positioning that results when the encoders that are provided in the first drive source 401 to the sixth drive source 406 which drive the first arm 12 to the sixth arm 17, respectively, are at their respective origins, that is, positioning that results when the basic positioning of all the first arm 12 to the sixth arm 17 is performed.

Furthermore, the basic positioning of each of the first arm 12 to the sixth arm 17 refers to the positioning that results when the encoder that is provided in the drive source which drives the arm is at its origin.

Furthermore, in the basic positioning of the second arm 13, the second arm 13 orthogonally intersects (intersects) the first rotation axis O1 when viewed from the axis direction of the second rotation axis O2. That is, the straight line 61 that passes through the second rotation axis O2 and the third rotation axis O3 orthogonally intersects (intersects) the first rotation axis O1 when viewed from the axis direction of the second rotation axis O2. In other words, the straight line 61 extends in the horizontal direction. Accordingly, by the second arm 13 rotates in the forward direction and the reverse direction while maintaining the basic positioning, for example, an job between a flank surface and a surface on which the robot 1 is installed, such as between the flank surface and the floor 51, can be quickly performed.

Furthermore, the basic positioning of the robot 1 may be changeable, and may be non-changeable.

In the robot 1 that is configured in this manner, as described above, the first rotation axis O1 and the second rotation axis O2 are present at the position for torsion, and the second rotation axis O2 is in parallel to the axis that orthogonally intersects (intersects) the first rotation axis O1. That is, as illustrated in FIG. 3, the second rotation axis O2 is positioned only the distance D0 (a separation distance) away from the first rotation axis when viewed from the axis direction of the second rotation axis O2. For this reason, access to the flank side of the robot 1 and the side (the base 11 side) of the surface on which the robot 1 is installed can be easily performed. For this reason, the robot 1 can be used for a wide variety of jobs in accordance with the application or the purpose of the robot 1.

As illustrated in FIGS. 11 to 13, in the robot 1, the robot arm 6 has a structure in which a cable 20 is regulable within the fourth arm 15. The cable 20 is an example of wiring. In the present embodiment, the cable 20 has a plurality of wires inside, and constitutes one portion of a member (a mechanism) that electrically connects the end encoder (not illustrated) which is attached to the front end of the sixth arm 17 and the control apparatus 200 to each other. That is, one end portion of the cable 20 is connected to a connector 1501 that is provided on a base end portion of the fourth arm 15, is inserted into the fourth arm 15 from a halfway flank surface of the fourth arm 15, and passes through the fourth arm 15, the fifth arm 16, and the sixth arm 17, and the other end portion of the cable 20 is connected to the end encoder. It is noted that the cable 20 is not limited to the configuration in which the connector 1501 and the end effector are electrically connected to each other, and for example, a configuration may be employed in which the control apparatus 200 and the end effector are integrated into one piece and are electrically connected to each other. The detail will be described below.

As illustrated in FIGS. 7 to 9, the fourth arm 15 has a guidance unit 3 that guides the cable 20 in a direction that is different from a direction (any direction on a plane, which makes a normal line with respect to the rotation axis O4) perpendicular to the fourth rotation axis O4. In the present embodiment, the guidance unit 3 guides the cable 20 along the fourth rotation axis O4 (refer to FIG. 11) on the front end side of the fourth arm 15, which is positioned more forward than an exit portion 312 described later.

The guidance unit 3 has a pair of lids 30 (refer to FIG. 10) that are detachably attached to a prescribed portion of the fourth arm 15. Accordingly, the cable 20 can be inserted into or removed from a through-hole 31. It is noted that in the present embodiment, each of the lids is screwed, but may be attached using other methods. Furthermore, a portion of each of the lids 30 of the guidance unit 3 may be formed on the fourth arm 15 in a manner that is not detachable from the fourth arm 15, for example, may be integrally formed with the fourth arm 15. The guidance unit 3 will be described below.

The guidance unit 3 has a pair of the through-holes 31 through which the cable 20 passes and which possibly guides the cable 20. The through-holes 31 each have an entrance portion 311 and a shared common exit portion 312 (an opening portion), and merge in the vicinity of the exit portion 312. In the present embodiment, the cable 20 is inserted into one through-hole 31, and the one through-hole 31 guides the cable 20 along the fourth rotation axis O4 on the front end side that is positioned more forward than the exit portion 312 (refer to FIG. 11).

That is, the guided cable 20 is positioned on the fourth rotation axis O4 on the front end side that is more forward than the exit portion 312, while maintaining basic positioning (a state where the fifth arm 16 is stretched) (refer to FIG. 11) of the fifth arm 16. Particularly, the cable 20 is positioned on the fourth rotation axis O4 while running from the exit portion 312 to an entrance portion of the through-hole 161 in the fifth arm 16.

At this point, the guided cable 20 is not limited to the case where the guided cable 20 is positioned on the fourth rotation axis O4, and may be in parallel to the fourth rotation axis O4.

Furthermore, the guided cable 20 may be inclined in a range of less than 90° with respect to the fourth rotation axis O4. In this case, an angle at which the cable 20 is inclined with respect to the fourth rotation axis O4 is preferably equal to or greater than 0° and equal to or smaller than 45° and is further preferably equal to or greater than 0° and equal to or smaller than 15°.

Furthermore, one or several portions, or all portions of the guided cable 20 may be inclined with respect to the fourth rotation axis O4.

Furthermore, the positioning of the through-hole is not particularly limited, but in the present embodiment, each of the through-holes 31 is positioned in a position that results from the 180° turning about the fourth rotation axis O4 when viewed from an axis direction of the fourth rotation axis O4.

Because the through-holes 31 are the same, one through-hole 31 will be representatively described below. It is noted that the through-holes 31 may be different from each other.

As illustrated in FIG. 11, the through-hole 31 has a portion that is inclined with respect to the fourth rotation axis O4 when viewed from an axis direction of the fifth rotation axis O5. That is, a portion of the through-hole 31, which is present between the entrance portion 311 and the exit portion 312, is inclined with respect to the fourth rotation axis O4 when viewed from the axis direction of the fifth rotation axis O5. Accordingly, the cable 20 can be precisely guided along the fourth rotation axis O4. An inclination angle (an angle) of the portion of the through-hole 31, which is present between the entrance portion 311 and the exit portion 312, with respect to the fourth rotation axis O4, is not particularly limited, and is suitably set according to all conditions. However, the inclination is preferably equal to or greater than 5° and equal to or smaller than 85°, is more preferably equal to or greater than 15° and equal to or smaller than 80°, and is further preferably equal to or greater than 45° and equal to or smaller than 75°. It is noted that the through-hole 31 may not be included with respect to the fourth rotation axis O4 when viewed from the axis direction of the fifth rotation axis O5.

Furthermore, the entrance portion 311 of the through-hole 31 is provided to the upper side in FIG. 11 of the fourth arm 15 on a flank surface of the fourth arm 15, that is, in an axis direction that is in parallel to an axis which orthogonally intersects each of the fourth rotation axis O4 and the fifth rotation axis O5.

Furthermore, a shape of an opening in the entrance portion 311 is not particularly limited, but in the present embodiment, is a rounded shape, such as a circular shape or an elliptical shape. Accordingly, the cable 20 can be inserted into the through-hole 31 from the entrance portion 311 easily and smoothly.

Furthermore, the entrance portion 311 takes a tapered shape, and a diameter of the entrance portion 311 decreases in the direction from the entrance portion 311 side to the exit portion 312 side.

Furthermore, the exit portion 312 of the through-hole 31 is the base end portion of the fourth arm 15, and is positioned on the fourth rotation axis O4 when viewed from the axis direction of the fourth rotation axis O4. That is, the fourth rotation axis O4 passes through the exit portion 312 (particularly, a center portion of the exit portion 312). Furthermore, a normal line with respect to an opening in the exit portion 312 is consistent with the fourth rotation axis O4. The exit portion 312 is an example of an opening portion through which the fourth rotation axis O4 passes.

Furthermore, a shape of the opening in the exit portion 312 is not particularly limited, but in the present embodiment, is a quadrangle, and in order to suppress frictional wear of the cable 20, a ridge line (a portion with which the cable 20 and the exit portion 312 come into contact) surrounded by four sides of the quadrangle is rounded.

Furthermore, in a state where the fifth arm 16 that is illustrated in FIG. 11 is stretched, that is, in the basic positioning of the fifth arm 16, the fifth arm 16 has a through-hole 161 that extends over the fourth rotation axis O4, and the sixth arm 17 has a through-hole 178 that extends over the fourth rotation axis O4. The through-hole 161 communicates with the through-hole 178 and the inside of the fourth arm 15. It is noted that the fifth arm 16 may not have the through-hole 161 and that the sixth arm 17 may not have the through-hole 178.

Next, movement of the cable 20 in a case where the fifth arm is caused to rotate will be described below.

As illustrated in FIG. 11, the cable 20 of which one end portion is connected to the connector 1501 is inserted into the through-hole 31 from the entrance portion 311 of the through-hole 31, is regulated in such a manner that a direction of the cable 20 in the exit portion 312 is toward the fourth rotation axis O4, and is guided along the fourth rotation axis O4. Furthermore, the cable 20 passes through the fourth arm 15, and passes through the through-hole 161 in the fifth arm 16 and the through-hole 178 in the sixth arm 17. The other end portion of the cable 20 is connected to the end encoder.

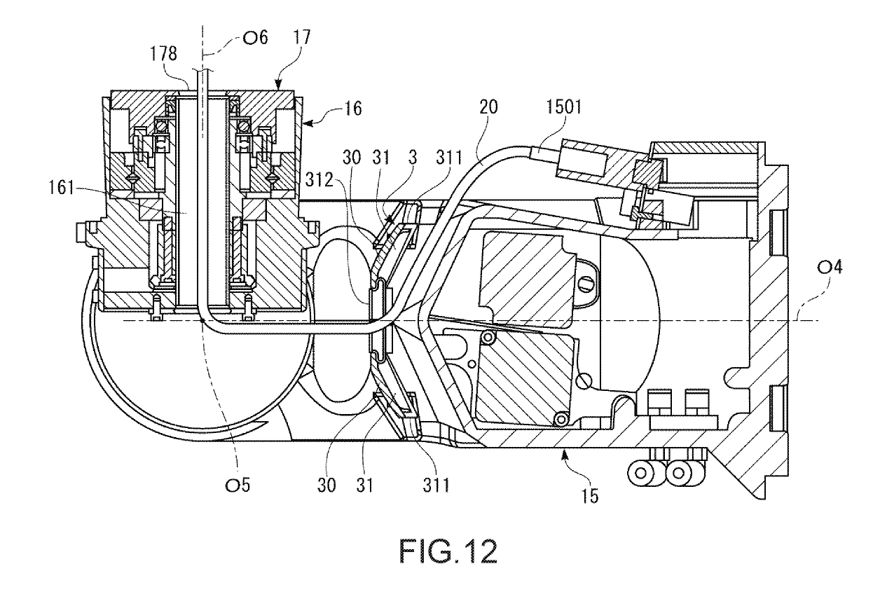

When, as illustrated in FIG. 12, the fifth arm 16 is caused to rotate by 90° in a clockwise direction in FIG. 12 from the state where the fifth arm 16 that is illustrated in FIG. 11 is stretched, that is, from the basic positioning of the fifth arm 16, the cable 20 is curved along with the fifth arm 16. In this case, because the cable 20 is guided by the guidance unit 3 along the fourth rotation axis O4, a difference in a necessary length of the cable 20 between the case where the fifth arm 16 is caused to rotate by 90° in the clockwise direction in FIG. 12 and the state where the fifth arm 16 is stretched decreases.

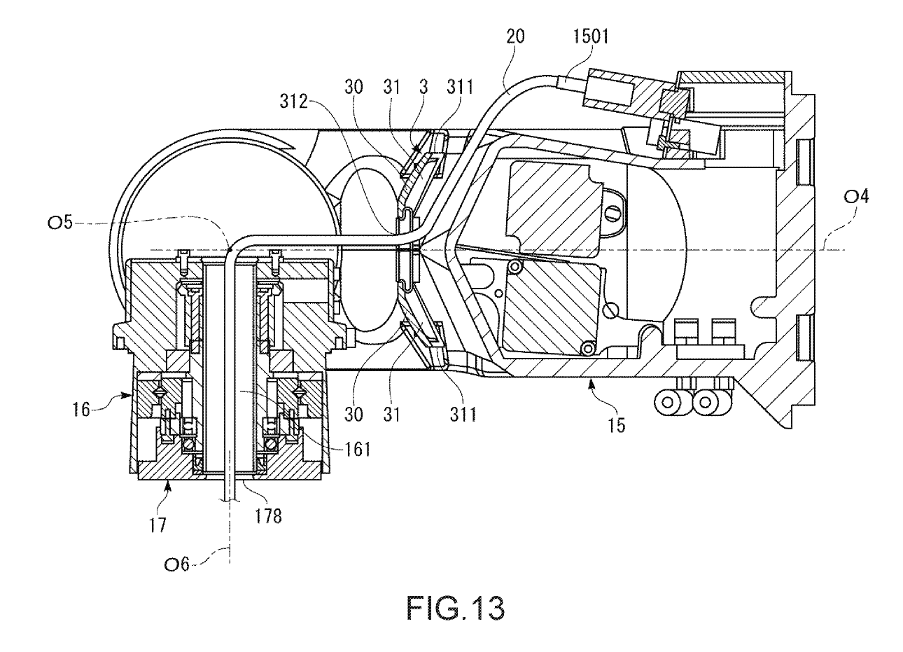

Furthermore, when, as illustrated in FIG. 13, the fifth arm 16 is caused to rotate by 90° in a counterclockwise direction in FIG. 13 from the state where the fifth arm 16 that is illustrated in FIG. 11 is stretched, the cable 20 is curved along with the fifth arm 16. In this case, because the cable 20 is guided by the guidance unit 3 along the fourth rotation axis O4, a difference in a necessary length of the cable 20 between the case where the fifth arm 16 is caused to rotate by 90° in the counterclockwise direction in FIG. 13 and the state where the fifth arm 16 is stretched decreases.

In this manner, the cable 20 is regulated by the guidance unit 3, and the cable 20 is guided along the fourth rotation axis O4. Thus, the difference in the necessary length of the cable between the case where the fifth arm 16 is straightened and the case where the fifth arm 16 is curved decreases. Furthermore, variation in the difference decreases as well. Accordingly, an extra length of the cable 20 can be shortened, and variation in the extra length of the cable 20 can be decreased.

As described above, with the robot 1, the cable can be precisely regulated within the fourth arm 15. Accordingly, the extra length of the cable 20 can be shortened, and the variation in the extra length of the cable 20 can be decreased. Then, accordingly, the robot 1 is possibly miniaturized.

Furthermore, as described above, in the robot 1, the second arm 13, the third arm 14, and the like are caused to rotate without causing the first arm 12 to rotate. Thus, the front end of the robot arm 6 can be caused to experience a state (the state where the first arm 12 and the second arm 13 overlap each other) where the angle θ° that the first arm 12 and the second arm 13 make with respect to each other is 0° when viewed from the axis direction of the second rotation axis O2 and then to move to the position that results from the 180° turning around the first rotation axis O1.

Accordingly, the space that is necessary in order for the robot 1 not to cause interference can be reduced.

That is, first, an area where the robot 1 operates in the width direction (the direction of a production line) can be decreased. Accordingly, as many robots 1 as possible per unit length can be arranged along the production line, and the production line can be shortened.

Furthermore, in a case where the front end of the robot arm 6 is caused to move, an amount of movement of the robot 1 can be decreased. For example, the first arm 12 is not caused to rotate or a rotation angle of the first arm can be decreased. Accordingly, the tact time can be shortened and job efficiency can be improved.

Furthermore, when an operation (hereinafter also referred to as a “short cut motion”) of causing the front end of the robot arm 6 to move to the position that results from the 180° turning around the first rotation axis O1 is performed by simply causing the first arm 12 to rotate around the first rotation axis O1 as in the robot in the related, there is a concern that the robot 1 will interfere with a wall (not illustrated) in the vicinity of the robot 1 or a neighboring apparatus (not illustrated). Because of this, there is a need to teach the robot 1 an evacuation point for avoiding the interference. For example, when only the first arm 12 is caused to rotate by 90° around the first rotation axis O1, in a case where the robot 1 interferes with the wall, there is a need to teach the evacuation point in such a manner that interference with the wall is not caused, by also causing another arm to rotate. In the same manner, in a case where the robot 1 also interferes with the neighboring apparatus, there is further a need to teach the evacuation point in such a manner that interference with the neighboring apparatus is not caused. There is a need to teach the robot in the related art many evacuations. Particularly, in a case where space in the vicinity of the robot 1 is small, a huge number of evacuation points are necessary, and much labor and a long time are required for the teaching.

In contrast, in the robot 1, in a case where the short cut motion is performed, because an area or a portion in which there is a concern that the interference will be caused can be considerably decreased, the number of evacuation points that are to be taught can be reduced and the labor and the time that are required for the teaching can be reduced. That is, in the robot 1, the number of evacuation points that are to be taught, for example, is approximately one third of that for the robot 1 in the relates art, and thus the teaching is dramatically easy.

Furthermore, areas (portions) of the third arm 14 and the fourth arm 15, which are opposite in direction to the second arm 13 in FIG. 1 (which are on the front side in FIG. 1) are areas (portions) in which the robot 1 does not interfere with members of the robot 1 itself and other robots, or has difficulty in interfering with the members of the robot 1 itself and other robots. For this reason, in a case where a prescribed member is mounted on the area, the member has difficulty in interfering with the robot 1, the neighboring apparatus, and the like. For this reason, in the robot 1, the prescribed member is possibly mounted on the area. Particularly, in a case where, among the areas, the prescribed member is mounted on the area of the third arm 14, which is opposite in direction to the second arm 13 in FIG. 1, this is more efficient because the probability that the member will interfere with the neighboring apparatus (not illustrated) which is positioned on a working stand that is not illustrated is further decreased.

As a member that is possibly mounted on the area, for example, a hand, a control device that controls drive of the hand or a sensor such as a hand-eye camera, an electromagnetic valve of an absorption mechanism, or the like is given.

As a specific example, for example, in a case where the absorption mechanism is provided on the hand, if the electromagnetic valve is installed on the area, the electromagnetic valve is not an obstacle when the robot 1 is driven. In this manner, the area is highly convenient.

It is noted that in the present embodiment, the cable 20 is positioned to be inserted into and pass through one through-hole 31 of the through-holes 31 in a pair, but no limitation to this is imposed. For example, the cable 20 may be positioned in such a manner that the cable 20 is inserted into and passes through the other through-hole 31 of the through-holes 31 in a pair.

Furthermore, in the present embodiment, the guidance unit 3 has the pair of the through-holes 31, but the number of through holes 31 is not limited to this. For example, one through-hole 31 may be available and three or more through-holes may be available. Furthermore, instead of the through-hole 31, a groove may be provided.

As described above, the robot 1 includes the fourth arm 15 (an n-th arm) that is rotatable around the fourth rotation axis O4 (an n-th (n is at least one integer that is equal to or greater than 1) rotation axis), and the fifth arm 16 (an (n+1)-th arm) that is provided on the fourth arm 15 (the n-th arm) in a manner that is rotatable around the fifth rotation axis O5 (an (n+1)-th rotation axis) in an axis direction that is different from an axis direction of the fourth rotation axis O4 (the n-th rotation axis). Furthermore, the fourth arm 15 (the n-th arm) has the exit portion 312 (the opening portion) that includes the fourth rotation axis O4 (the n-th rotation axis) when viewed from the axis direction of the fourth rotation axis (the n-th rotation axis), and the guidance unit 3 that guides the cable 20 (wiring) in a direction that is different from a direction which is perpendicular to the fourth rotation axis O4 (the n-th rotation axis).

With the robot 1 that is configured in this manner, the cable 20 can be precisely regulated within the fourth arm 15, and thus the extra length of the cable 20 can be shortened, and the variation in the extra length of the cable 20 can be decreased.

Furthermore, the guidance unit 3 guides the cable 20 (the wiring) along the fourth rotation axis O4 (the n-th rotation axis). Accordingly, the extra length of the cable can be precisely shortened, and the variation in the extra length of the cable 20 can be decreased.

Further, the fifth arm 16 (the (n+1)-th arm) has the through-hole 161, and the cable 20 (the wiring) passes through the through-hole 161. Accordingly, the cable 20 can be inserted into and pass through the through-hole 161, and the cable 20 can be connected to the end effector.

Furthermore, the guidance unit 3 has a portion that causes a guidance direction of the cable 20 (the wiring) to be inclined with respect to the fourth rotation axis O4 (the n-th rotation axis). Accordingly, the cable 20 can be precisely guided.

Furthermore, the guidance unit 3 has the lid 30 (a portion) that is attachable to and detachable from at least the fourth arm 15 (the n-th arm). Accordingly, the cable 20 can be easily provided within the fourth arm 15.

Furthermore, the control apparatus 200 (the robot control apparatus) controls the drive of the robot 1.

With the control apparatus 200 that is configured in this manner, the robot 1 that is controlled can precisely regulate the cable 20 within the fourth arm 15, and thus the extra of the cable 20 can be shortened, and the variation in the extra length of the cable 20 can be decreased.

Furthermore, the robot system 100 includes the robot 1 and the control apparatus 200 (the robot control apparatus) that controls the drive of the robot 1.

With the robot system 100 that is configured in this manner, the cable 20 can be precisely regulated within the fourth arm 15, and thus the extra length of the cable 20 can be shortened, and the variation in the extra length of the cable 20 can be decreased.

### Second Embodiment

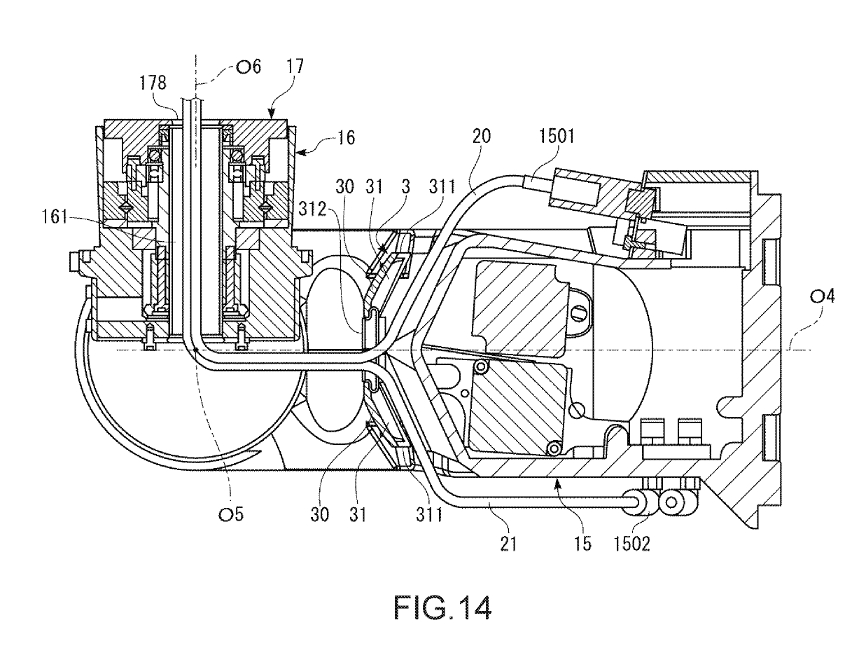

FIG. 14 is a cross-sectional diagram a fourth arm, a fifth arm, and a sixth arm in a robot (a robot system) according to a second embodiment of the invention.

The second embodiment will be described below. A difference with the embodiment described above is emphatically described and a description of the same matter is omitted.

As illustrated in FIG. 14, in a robot 1 (a robot system 100) (refer to FIG. 1) according to the second embodiment, two cables, cables 20 and 21 are provided.

As in the first embodiment, the cable 20 is inserted into and passes through one through-hole 31 of the through-holes 31 in a pair, of the guidance unit 3. Furthermore, the cable 21 is inserted into and passes through the other through-hole 31 of the through-holes 31 in a pair, of the guidance unit 3. By doing this, the guidance unit 3 regulates two cables, the cables 20 and 21, and guides the cables 20 and 21 along the fourth rotation axis O4.

According to the second embodiment that is configured in this manner, the same effect as that according to the first embodiment described above can also be achieved.

Furthermore, in the robot 1, a plurality of wires can be divided into the cable 20 and the cable 21, and the suitable division of the plurality of wires is possible according to the end effector.

### Third Embodiment

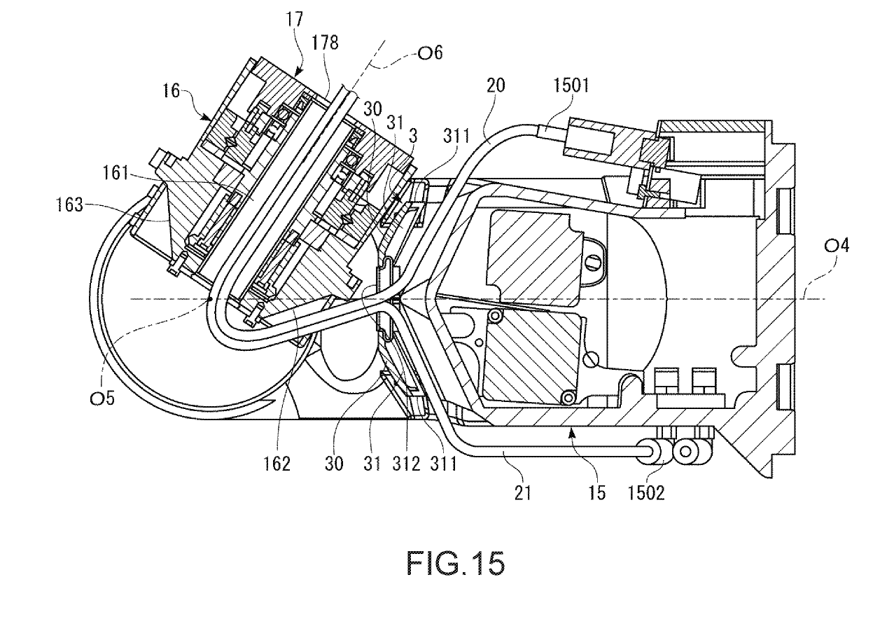

FIG. 15 is a cross-sectional diagram of a fourth arm, a fifth arm, and a sixth arm in a robot (a robot system) according to a third embodiment of the invention.

The third embodiment will be described below. A difference with the embodiments described above is emphatically described and a description of the same matter is omitted.

As illustrated in FIG. 15, in a robot 1 (a robot system 100) (refer to FIG. 1) according to the third embodiment, as in the second embodiment, two cables, the cables 20 and 21 are provided.

Furthermore, within the fourth arm 15, inclination portions 162 and 163 that take a shape which results from removing corner portions (one or several portions) of the structure within the fourth arm 15 according to the second embodiment are formed.

With the inclination portion 162, in a case where, as illustrated in FIG. 15, the fifth arm 16 is caused to rotate in a clockwise direction in FIG. 15 by an angle that exceeds 90° from the state where the fifth arm 16 is stretched, the cable 20 can be suppressed from interfering with a structure within the fourth arm 15.

In the same manner, with the inclination portion 163, in a case where the fifth arm 16 is caused to rotate in a counterclockwise direction in FIG. 15 by an angle that exceeds 90° from the state where the fifth arm 16 is stretched (this case is not illustrated), the cable 20 can be suppressed from interfering with the structure within the fourth arm 15.

According to the third embodiment that is configured in this manner, the same effect as those according to the embodiments described above can also be achieved.

### Fourth Embodiment

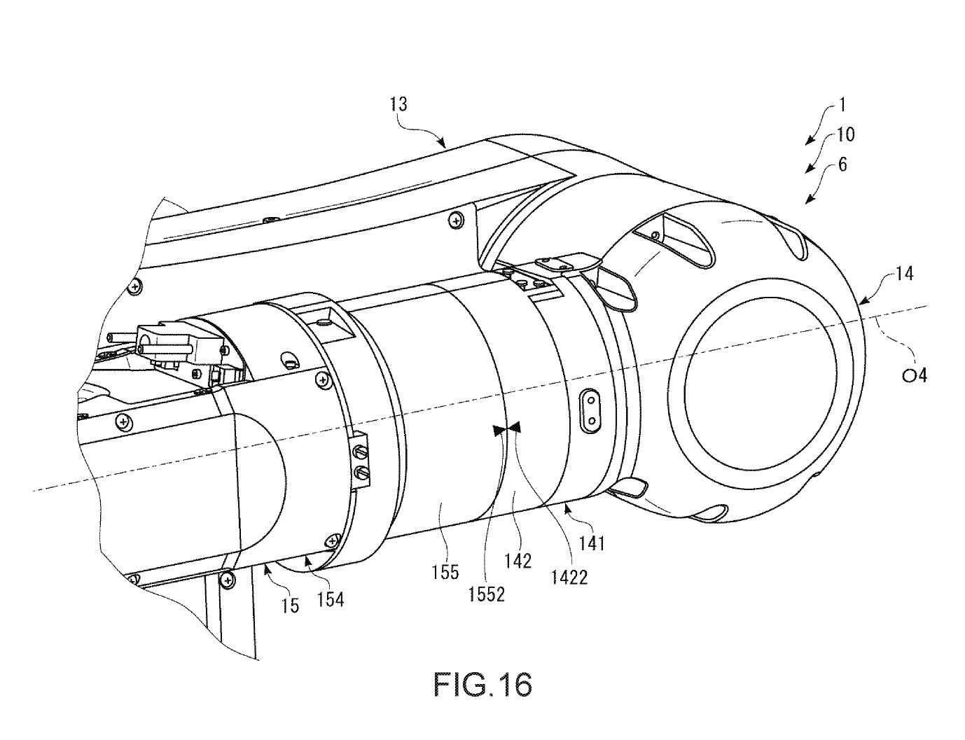

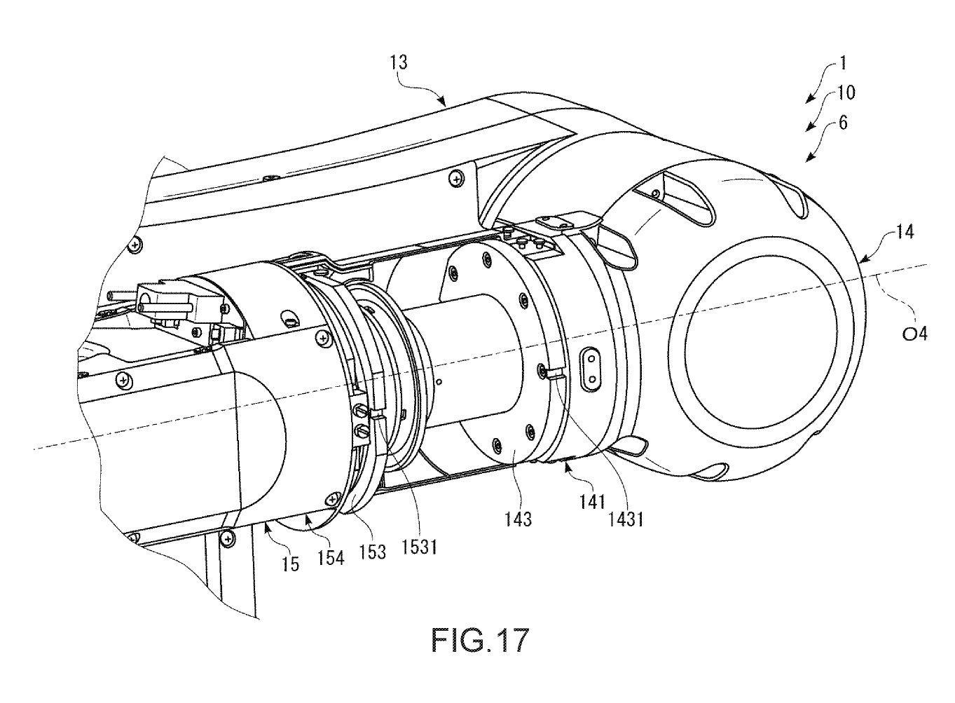

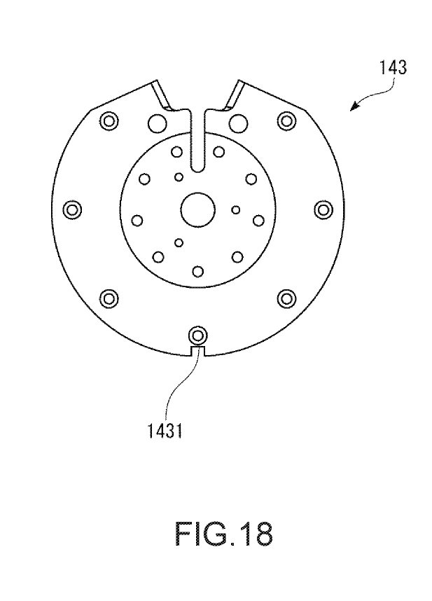

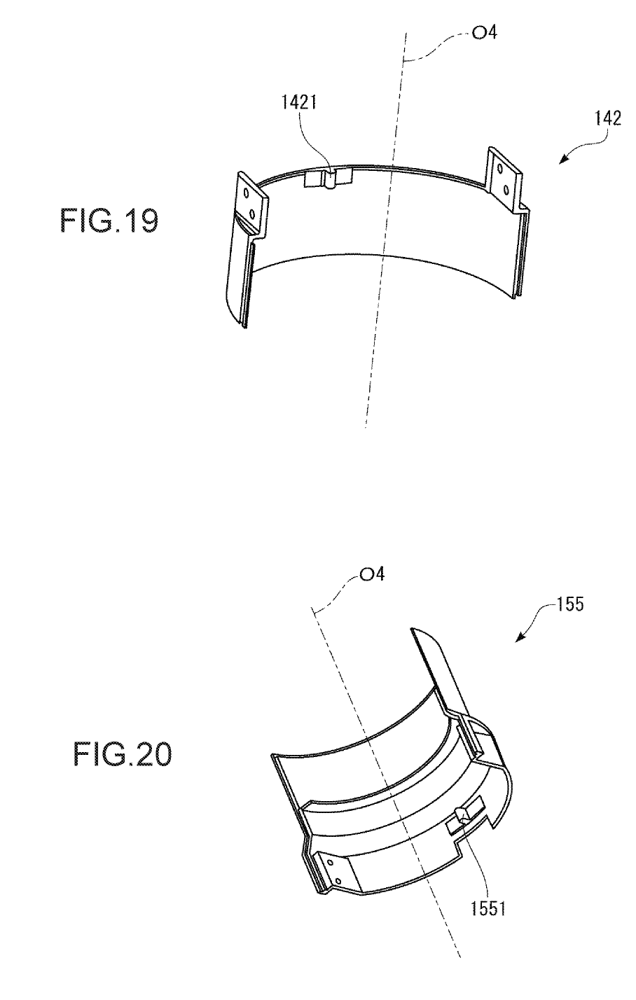

FIG. 16 is a perspective diagram illustrating a robot (a robot system) according to a fourth embodiment of the invention. FIG. 17 is a perspective diagram illustrating a state where a cover is removed in the robot that is illustrated in FIG. 16. FIG. 18 is a front-view diagram illustrating a component of the robot arm of the robot that is illustrated in FIG. 16. FIGS. 19 and 20 are diagrams each of which illustrates the cover of the robot arm of the robot that is illustrated in FIG. 16.

The fourth embodiment will be described below. A difference with the embodiments described above is emphatically described and a description of the same matter is omitted.

As illustrated in FIGS. 16 and 17, in a robot 1 (a robot system 100) (refer to FIG. 1) according to the fourth embodiment, the third arm 14 includes an arm main-body unit 141 and a cover 142 that is detachably attached to the arm main-body unit 141.

The arm main-body unit 141 has an attachment member 143 to which the cover 142 is attached, which is illustrated in FIGS. 17 and 18. The attachment member 143 is a shape that results from removing one portion of a circular plate, and has a groove 1431 (a recessed portion) in an outer circumferential portion thereof.

Furthermore, as illustrated in FIGS. 16 and 19, the cover 142 takes the shape of an arc when viewed from the axis direction of the fourth rotation axis O4, and has a rib 1421 (a projecting portion) that is possibly engaged with the groove 1431 in the attachment member 143, in an inner circumferential portion thereof. Furthermore, a position of the rib 1421 or a direction in which the rib 1421 extends is not particularly limited, but in the present embodiment, the rib 1421 is positioned in a center portion of the cover 142 when viewed from the axis direction of the fourth rotation axis O4. Furthermore, in the present embodiment, the rib 1421 and the groove 1431 each extend in an axis direction that is in parallel to the axis direction of the fourth rotation axis O4.

Further, the cover 142 has a marker 1422 (an index) in an outer circumstantial portion thereof. A shape of the marker 1422 is not particularly limited, but in the present embodiment, is the shape of a triangle. Furthermore, a method of forming the marker 1422 is not particularly limited, and the marker 1422, for example, is possibly provided by performing display in a color different from those of the surroundings or forming the recessed portion or the projecting portion.

Furthermore, the fourth arm 15 has an arm main-body unit 154 and a cover 155 that is detachably attached to the arm main-body unit 154.

The arm main-body unit 154 has an attachment member 153 to which the cover 155 is attached, which is illustrated in FIG. 17. The attachment member 153 is a shape that results from removing one portion of a circular plate, and has a groove 1531 (a recessed portion) in an outer circumferential portion thereof.

Furthermore, as illustrated in FIGS. 16 and 20, the cover 155 takes the shape of an arc when viewed from the axis direction of the fourth rotation axis O4, and has a rib 1551 (a projecting portion) that is possibly engaged with the groove 1531 in the attachment member 153, in an inner circumferential portion thereof. Furthermore, a position of the rib 1551 or a direction in which the rib 1551 extends is not particularly limited, but in the present embodiment, the rib 1551 is positioned in a center portion of the cover 155 when viewed from the axis direction of the fourth rotation axis O4. Furthermore, in the present embodiment, the rib 1551 and the groove 1531 each extend in the axis direction that is in parallel to the axis direction of the fourth rotation axis O4.

Further, the cover 155 has a marker 1552 (an index) in an outer circumstantial portion thereof. A shape of the marker 1552 is not particularly limited, but in the present embodiment, is the shape of a triangle. Furthermore, a method of forming the marker 1552 is not particularly limited, and the marker 1552, for example, is possibly provided by performing display in a color different from those of the surroundings or forming the recessed portion or the projecting portion.

At this point, the rib 1421 of the cover 142 and the groove 1431 in the attachment member 143 are provided in such a manner that, in a case where the rib 1421 and the groove 1431 are engaged with each other, a positional relationship between the arm main-body unit 141 and the cover 142 is a suitable positional relationship.

The groove 1431 and the rib 1421 are an example of a first position determination unit for performing alignment (positioning) between the arm main-body unit 141 and the cover 142.

In the same manner, the rib 1551 of the cover 155 and the groove 1531 in the attachment member 153 are provided in such a manner that, in a case where the rib 1551 and the groove 1531 are engaged with each other, a positional relationship between the arm main-body unit 154 and the cover 155 is a suitable positional relationship.

The groove 1531 and the rib 1551 are an example of a first position determination unit for performing alignment between the arm main-body unit 154 and the cover 155.

Furthermore, the marker 1422 of the cover 142 and the marker 1552 of the cover 155 are provided in such a manner that, in a case where the marker 1422 and the marker 1552 are consistent with each other, a positional relationship between the third arm 14 and the fourth arm 15 is a suitable positional relationship.

Specifically, in the present embodiment, positioning of the fourth arm 15 that is illustrated in FIGS. 1 and 3 is correct basic positioning of the fourth arm 15, but, the markers 1422 and 1552 are provided in such a manner that, as illustrated in FIG. 16, the positioning of the fourth arm 15 in a case where the marker 1422 and the marker 1552 are consistent with each other is the correct basic positioning thereof.

The marker 1422 and the marker 1552 are an example of a second position determination unit for performing alignment between the third arm 14 and the fourth arm 15.

Furthermore, the grooves 1431 and 1531, the ribs 1421 and 1551, and the markers 1422 and 1552 are an example of a position determination unit for performing alignment between the third arms 14 and the fourth arm 15.

In a case where the covers 142 and 155 are removed and maintenance or the like is performed and then where the covers 142 and 155 are attached, one of the cover 142 and the cover 155 is first attached to an arm main-body unit to which the one corresponds.

In a case where the cover 142 is attached to the arm main-body unit 141, the rib 1421 of the cover 142 and the groove 1431 in the arm main-body unit 141 are engaged with each other and alignment (positioning) of the cover 142 with respect to the arm main-body unit 141 is performed. Accordingly, the cover 142 can be attached easily, quickly, and precisely to the arm main-body unit 141 while maintaining suitable positioning. Furthermore, because the rib 1421 is provided on a center portion of the cover 142 when viewed from the axis direction of the fourth rotation axis O4, the alignment can be accurately performed. It is noted that in the present embodiment, the cover 142 is set to be screwed, but may be set to be attached using other methods.

In the same manner, in a case where the cover 155 is attached to the arm main-body unit 154, the rib 1551 of the cover 155 and the groove 1531 in the arm main-body unit 154 are engaged with each other and alignment (positioning) of the cover 155 with respect to the arm main-body unit 154 is performed. Accordingly, the cover 155 can be attached easily, quickly, and precisely to the arm main-body unit 154 while maintaining suitable positioning. Furthermore, because the rib 1551 is provided on the center portion of the cover 155 when viewed from the axis direction of the fourth rotation axis O4, the alignment can be accurately performed. It is noted that in the present embodiment, the cover 155 is set to be screwed, but may be set to be attached using other methods.

Next, a rotation angle of the fourth arm 15 is adjusted, and the marker 1552 of the fourth arm 15, and the marker 1422 of the third arm 14 are caused to be consistent with each other. Then, a fourth encoder (not illustrated) that is provided on a fourth drive source 404 is reset. Accordingly, in a state where the position of the fourth arm 15 is the correct basic positioning, the fourth encoder is reset (to the original position).

According to the fourth embodiment that is configured in this manner, the same effect as those according to the embodiments described can also be achieved.

Furthermore, in the robot 1, in a case where maintenance of the robot 1 or the like is performed, the maintenance or the like can be performed easily by detaching the covers 142 and 155. Then, after the maintenance is ended, in a case where the covers 142 and 155 are attached, the positioning of the fourth arm 15 with respect to the third arm 14 can be easily and quickly set to be suitable positioning (for example, the basic positioning).

It is noted that in the present embodiment, the cover 142 has the rib 1421 and the attachment member 143 has the groove 1431, but no limitation to this is imposed, and that for example, the cover 142 may have a groove (a recessed portion) and the attachment member 143 may have a rip (a projecting portion) that is possibly engaged with the groove.

Furthermore, in the present embodiment, the cover 155 has the rib 1551 and the attachment member 153 has the groove 1531, but no limitation to this is imposed. For example, the cover 155 may have a groove (a recessed portion) and the attachment member 153 may have a rip (a projecting portion) that is possibly engaged with the groove.

As described above, the robot 1 includes the third arm 14 (an m-th arm) that is rotatable around the third rotation axis O3 (an m-th rotation axis), and the fourth arm 15 (an (m+1)-th arm) that is provided on the third arm 14 (the m-th arm) in a manner that is rotatable around the fourth rotation axis O4 (an (m+1)-th rotation axis) in an axis direction that is different from an axis direction of the third rotation axis O3 (the m-th rotation axis).

Furthermore, the third arm 14 (the m-th arm) and the fourth arm 15 (the (m+1)-th arm) have the covers (the covers 142 and 155), respectively, that have the position determination units (the grooves 1431 and 1531, the ribs 1421 and 1551, and the markers 1422 and 1552), respectively, for the alignment between the third arm 14 (the m-th arm) and the fourth arm 15 (the (m+1)-th arm).

Accordingly, in a case where the maintenance of the robot 1 or the like is performed, the maintenance or the like can be performed easily by detaching the covers 142 and 155. Then, after the maintenance is ended, in a case where the covers 142 and 155 are attached, with the grooves 1431 and 1531, the rib 1421 and 1551, and the markers 1422 and 1552, the positioning of the fourth arm 15 with respect to the third arm 14 can be easily and quickly set to be the suitable positioning (for example, the basic positioning).

More specifically, the robot 1 includes the third arm 14 (the m-th arm) that is rotatable around the third rotation axis O3 (the m-th rotation axis), and the fourth arm 15 (the (m+1)-th arm) that is provided on the third arm 14 (the m-th arm) in a manner that is rotatable around the fourth rotation axis O4 (the (m+1)-th rotation axis) in the axis direction that is different from the axis direction of the third rotation axis O3 (the m-th rotation axis).

Furthermore, the third arm 14 (the m-th arm) and the fourth arm 15 (the (m+1)-th arm) have the arm main-body units (the arm main-body units 141 and 154) and the covers (the covers 142 and 155), respectively. The covers (the covers 142 and 155) include the first position determination units (the grooves 1431 and 1531 and the ribs 1421 and 1551) for the alignments between the arm main-body units (the arm main-body units 141 and 154) and the covers (the covers 142 and 155), respectively, and the second position determination units (the markers 1422 and 1552) for the alignment between the third arm 14 (the m-th arm) and the fourth arm 15 (the (m+1)-th arm).

Accordingly, in the case where the maintenance of the robot 1 or the like is performed, the maintenance or the like can be performed easily by detaching the covers 142 and 155. Then, after the maintenance is ended, in a case where the covers 142 and 155 are attached, with the grooves 1431 and 1531, the ribs 1421 and 1551, and the markers 1422 and 1552, the positioning of the fourth arm 15 with respect to the third arm 14 can be easily and quickly set to be the suitable positioning (for example, the basic positioning).

The robot, the robot control apparatus, and the robot system according to the invention are described above based on the illustrated embodiments, but the invention is not limited to this. Any configuration of a unit that has the same function can be substituted for the configuration of each unit. Furthermore, any other constituent element may be added. Furthermore, the invention may result from combining any two or more configurations (features).

Furthermore, in the embodiments described above, a place where the base of the robot is fixed is a floor in the installation space, but the invention is not limited to this. Other places, for example, a ceiling, a wall, a working stand, and the ground are given.

Furthermore, according to the robot may be installed within a cell. In this case, as the places where the base of the robot is fixed, for example, a floor portion, a ceiling portion, and a wall portion of the cell and a working stand in the cell are given.

Furthermore, in the embodiments described above, a first surface that is a plane (a surface), where the robot (the base) is fixed, is a plane (a surface) in parallel to a horizontal surface, but the invention is not limited to this. For example, the first surface may be a plane (a surface) that is inclined with respect to a horizontal surface or a vertical surface and may be a plane (a surface) in parallel to the vertical surface. That is, a first rotation axis may be inclined with respect to the vertical direction or the horizontal direction, and may extend in the horizontal direction.

Furthermore, in the embodiments described above, the number of the rotation axes of the robot arm that the robot has is 6, but the invention is not limited to this. The number of the rotation axes of the robot arm, for example, may be 2, 3, 4, or 5, or is equal to or greater than 7. Furthermore, in the embodiments described above, the number of the arms that the robot has is 6, but the invention is not limited to this. The number of the arms that the robot has is, for example, 2, 3, 4, or 5, or is equal to or greater than 7. In this case, for example, in the robots according to the embodiments described above, an arm is added between the second arm and the third arm, and thus the robot that has the robot arms of which the number is 7 can be realized.

Furthermore, in the embodiments described above, the number of the arms that the robot has is 1, but the invention is not limited to this. The number of the arms that the robot has, for example, is equal to or greater than 2. That is, the robot, for example, may be a robot with a plurality of arms, such as a two-arm robot.

Furthermore, according to the invention, the robot may be a robot in another form. As a specific example, furthermore, a multiped walking (traveling) robot that has legs is cited.

Furthermore, in the embodiments described above, regarding a condition (relationship) for the n-th rotation axis, the n-th arm, the (n+1)-th rotation axis, and the (n+1)-th arm, the case where n is 4, that is, the case where the condition is satisfied in the fourth rotation axis, the fourth arm, the fifth rotation axis, and the fifth arm, is described, but the invention is not limited to this. N may be at least one integer that is equal to or greater than 1, and when n is any integer that is equal to or greater than 1, the same condition as in a case where the n is 4 may be satisfied.

Furthermore, in the embodiments described above, regarding a condition (relationship) for the m-th rotation axis, the m-th arm, the (m+1)-th rotation axis, and the (m+1)-th arm, the case where m is 3, that is, the case where the condition is satisfied in the third rotation axis, the third arm, the fourth rotation axis, and the fourth arm, is described, but the invention is not limited this. M is at least one integer that is equal to or greater than 1, and when m is any integer that is equal to or greater than 1, the same condition as in a case where the m is 3 may be satisfied. Furthermore, in the invention, n and m may be the same, or may be different from each other.

The entire disclosure of Japanese Patent Application No. 2017-094937, filed May 11, 2017 is expressly incorporated by reference herein.

What is claimed is:

1. A robot comprising:
an n-th (n is at least one integer that is equal to or greater than 1) arm that is rotatable around an n-th rotation axis; and
an (n+1)-th arm that is connected to the n-th arm in a manner that is rotatable around an (n+1)-th rotation axis in an axis direction that is different from an axis direction of the n-th rotation axis,
wherein the n-th arm has an opening portion that includes the n-th rotation axis when viewed from the axis direction of the n-th rotation axis and has a guide that guides wiring in a direction that is different from a direction which is perpendicular to the n-th rotation axis.

2. The robot according to claim 1,
wherein the guide guides the wiring along the n-th rotation axis.

3. The robot according to claim 1,
wherein the (n+1)-th arm has a through-hole, and the wiring passes through the through-hole.

4. The robot according to claim 2,
wherein the (n+1)-th arm has a through-hole, and the wiring passes through the through-hole.

5. The robot according to claim 1,
wherein the guide has a portion that causes a direction of guiding the wiring to be inclined with respect to the n-th rotation axis.

6. The robot according to claim 2,
wherein the guide has a portion that causes a direction of guiding the wiring to be inclined with respect to the n-th rotation axis.

7. The robot according to claim 3,
wherein the guide has a portion that causes a direction of guiding the wiring to be inclined with respect to the n-th rotation axis.

8. The robot according to claim 1,
wherein the guide has a portion that is detachably attached to at least the n-th arm.

9. The robot according to claim 1, further comprising:
an m-th (m is at least one integer that is equal to or greater than 1) arm that is rotatable around an m-th rotation axis; and
an (m+1)-th arm that is connected to the m-th arm in a manner that is rotatable around an (m+1)-th rotation axis in an axis direction that is different from an axis direction of the m-th rotation axis,
wherein at least one of the m-th arm and the (m+1)-th arm includes a cover that has a position determination unit for performing alignment between the m-th arm and the (m+1)-th arm.

10. The robot according to claim 1, further comprising:
an m-th (m is at least one integer that is equal to or greater than 1) arm that is rotatable around an m-th rotation axis; and
an (m+1)-th arm that is connected to the m-th arm in a manner that is rotatable around an (m+1)-th rotation axis in an axis direction that is different from an axis direction of the m-th rotation axis,
wherein at least one of the m-th arm and the (m+1)-th arm has an arm main-body unit and a cover, and
wherein the cover includes
a first position determination unit for performing alignment between the arm main-body unit and the cover, and
a second position determination unit for performing alignment between the m-th arm and the (m+1)-th arm.

11. A robot system comprising:
a robot that includes an n-th (n is at least one integer that is equal to or greater than 1) arm that is rotatable around an n-th rotation axis, and an (n+1)-th arm that is connected to the n-th arm in a manner that is rotatable around an (n+1)-th rotation axis in an axis direction that is different from an axis direction of the n-th rotation axis, and
a robot control apparatus that controls drive of the robot,
wherein the n-th arm has an opening portion that includes the n-th rotation axis when viewed from the axis direction of the n-th rotation axis and has a guide that guides wiring in a direction that is different from a direction which is perpendicular to the n-th rotation axis.

12. The robot system according to claim 11,
wherein the guide guides the wiring along the n-th rotation axis.

13. The robot system according to claim 11,
wherein the (n+1)-th arm has a through-hole, and the wiring passes through the through-hole.

14. The robot system according to claim 12,
wherein the (n+1)-th arm has a through-hole, and the wiring passes through the through-hole.

15. The robot system according to claim 11,
wherein the guide has a portion that causes a direction of guiding the wiring to be inclined with respect to the n-th rotation axis.

16. The robot system according to claim 12,
wherein the guide has a portion that causes a direction of guiding the wiring to be inclined with respect to the n-th rotation axis.

17. The robot system according to claim 13,
wherein the guide has a portion that causes a direction of guiding the wiring to be inclined with respect to the n-th rotation axis.

18. The robot system according to claim 11,
wherein the guide has a portion that is detachably attached to at least the n-th arm.

19. The robot system according to claim 11, further comprising:
an m-th (m is at least one integer that is equal to or greater than 1) arm that is rotatable around an m-th rotation axis; and
an (m+1)-th arm that is connected to the m-th arm in a manner that is rotatable around an (m+1)-th rotation axis in an axis direction that is different from an axis direction of the m-th rotation axis,
wherein at least one of the m-th arm and the (m+1)-th arm includes a cover that has a position determination unit for performing alignment between the m-th arm and the (m+1)-th arm.

20. The robot system according to claim 11, further comprising:
an m-th (m is at least one integer that is equal to or greater than 1) arm that is rotatable around an m-th rotation axis; and
an (m+1)-th arm that is connected to the m-th arm in a manner that is rotatable around an (m+1)-th rotation axis in an axis direction that is different from an axis direction of the m-th rotation axis,
wherein at least one of the m-th arm and the (m+1)-th arm has an arm main-body unit and a cover, and
wherein the cover includes
a first position determination unit for performing alignment between the arm main-body unit and the cover, and
a second position determination unit for performing alignment between the m-th arm and the (m+1)-th arm.
